(19) United States
(12) Patent Application Publication
(10) Pub. No.: US 2004/0221723 A1
(43) Pub. Date: Nov. 11, 2004

(54) Food and drink managing device in circulation type carrying path

(75) Inventors: Yuichi Ishino, Kanazawa-shi (JP); Minoru Sakurai, Kanazawa-shi (JP)

Correspondence Address: CHAPMAN AND CUTLER, 111 WEST MONROE STREET, CHICAGO, IL, 60603, US

(73) Assignee: ISHINO SEISAKUSYO Co., Ltd., Kanazawa-shi (JP)

(21) Appl. No.: 10/758,788

(22) Filed: Jan. 16, 2004

(30) Foreign Application Priority Data
Jan. 18, 2003 (JP) 2003-45148

(51) Int. Cl. A23L 1/00

(52) U.S. Cl. 99/275

(57) ABSTRACT

(Problem to be Solved) The purpose of present invention is that in standardizing while adding the reduced food and drink on carrying path, the food and drink managing device in circulation type carrying path will be offered, which enables to ease management and conduct, hold down the cost of whole device, and further achieve the precise identification information reading.

(Solution) The food and drink managing device in circulation type carrying path has food/drink containers 3 with identification information, an identification information reading means 5 provided near said circulating carrying path 2, at least one sign parts 4 circulating and moving as linked with said circulating carrying path 2, a pass-through detection means 5 for detecting passing through of said sign parts 4, a registering means 6 which divides an interval between passing sign parts 4 to be one zone, and registers the identification information of the containers 3 read by said identification information reading means 5, as foods and drinks in supplying, by coordinating it with a zone in which the containers exist, and food/drink containers throwing-in prohibited area W with the given length from the place of provided identification information reading means 5 towards the upper side of circulation carrying path.

### BACKGROUND OF THE INVENTION

(1) Field of the Invention

Present invention relates to the food and drink managing device that manages the food and drink in the circulation type carrying path that conveys food and drink.

(2) Related Art Statement

Heretofore, the dinning circulation carrying type dinning counter is widely used, which has the endless circulation type carrying path for conveying food and drink along the dining table, such as counter, and conveys the containers, such as the plates arranged by food and drink, for example Sushi, on this carrying path, because it enables customer or cook to eat and drink, or prepare the foods without moving, and also enables customer to choose and eat the food and drink that they want while sitting.

In the circulation carrying type dinning counter as aforesaid, the prescribed quantity and variety of food and drink on the carrying path may decrease because the customer chooses the conveying food and drink on the carrying path by their favor. Therefore, it is difficult to supply the sufficient service.

Consequently, the supply of the reduced food and drink on the carrying path will be essential. However, there was problems such as it is difficult to be aware of all the quantity of each variety of food and drink on the carrying path, and supply the quantity sufficiently without excess and deficiency, and requires lot of workload, and also, is difficult to be standardized and generalized because it is decided by one's experience what kind of food and drink and how much they are supplied.

In order to solve the above-described problems, the system that standardizes and generalizes the thing such as to supply by knowing the condition of food and drink on the carrying path, is known by the one described in prior patent documents 1 or 2. This system manages the food and drink on the carrying path by putting the individual ID to the mutual food/drink containers in advance, registering this ID and the classification of food and drink in relation before throwing-in, and detecting the ID through the carrying path. However, in order to manage these foods and drinks on the carrying path precisely with real-time, since the carrying path is relatively long, it is necessary to set many ID reading devices near the carrying path, which lead the problems such as complicating the device and raising the cost.

In these circumstances, to improve the food and drink managing system more is already suggested by the one described in prior patent document 3. This improved food and drink managing system divides the numbers of circulating food/drink container in several zones and manages the throwing-in and taking of food/drink container in each zone. It has the advantages to reduce the cost of whole device and to ease the management and conduct without huge loss of real-time quality or increase of conducting charges.

(Prior Patent Document 1)

Publication of Japanese Patent Application No. H8-238157 (cf. claims, claim 1)

(Prior Patent Document 2)

Publication of Japanese Patent Application No. H9-44753 (cf. claim 1, FIG. 1-3)

(Prior Patent Document 3)

Publication of Japanese Patent Application No. 2003-17546 (cf. claim 1, FIG. 1)

### SUMMARY OF THE INVENTION

However, in the above improved food and drink managing system, there were cases that identification information reading device did not read the ID precisely, because when a person tries to add the food/drink container to circulation carrying path near the identification information reading device, if the food/drink containers exist on the throwing-in area, it meant that the added food/drink container will push through those food/drink containers and the food/drink containers which are in the lower part than throwing-in area are temporarily running or overlapping with another one.

By thinking over the above condition, the purpose of present invention is that in standardizing while adding the reduced food and drink on carrying path, the food and drink managing device in circulation type carrying path will be offered, which enables to ease management and conduct, hold down the cost of whole device, and further achieve the precise identification information reading.

### BRIEF DESCRIPTION OF THE DRAWINGS

FIG. 1 is a view showing a squinting overview frame format of dining counter which has circulation type carrying path complete with food and drink managing device of present invention example.

FIG. 2 is a squinting view near the throwing-in area of kitchen side of circulating type carrying path of present invention example.

FIG. 3 is a partly fractured squinting overview that shows the Sushi plate that has the ID tag built-in, which is food/drink container used in present invention example.

FIG. 4 is a squinting view that shows the fixing condition of sign parts that have the ID tag built-in, to circulation type carrying path used in present invention example.

FIG. 5 is a block diagram that shows the structure of food and drink managing device of present invention example.

FIGS. 6(a), (b) are the explanation drawings to explain the managing condition of food and drink-managing device of present invention example.

FIG. 7(a) is a table that shows the organization of supplying Sushi data base in food and drink managing device in present invention example. FIG. 7(b) is a table that shows the organization of finished Sushi data base in food and drink managing device in present invention example.

FIG. 8 is a drawing that shows the screen to set the retention time in the managing computer of present invention example.

FIG. 9 is the plain diagram view near the throwing-in area that shows the another example of throwing-in prevention wall in food and drink managing device of present invention example.

FIG. 10 is the view that shows the placement of the tunnel-shaped-cover in the prohibited area of throwing-in food/drink container in food and drink managing device of present invention example. (a) is the cross-section diagram A-A of (b). (b) is the side view near the throwing-in area.

FIG. 11 is the drawing that shows the Sushi plate with bar code for another method of reading the ID without touching.

### DESCRIPTION OF CODE

1 Dinning counter

2 Carrying path (Flat top chain conveyor)

2′ Throwing in area

3, 3′ Sushi plate

4 Sign parts

4′ Screw parts

5,5′,5A,5B Reading unit Identification information reading means, passage detection means)

6 Managing computer (registering means)

7 Display

8 Crescent stat

9 Rotating axis

Data bus

11 Central Processing Unit (CPU)

12 RAM

13 Communication interface

14 Display interface

15 Memory device

16 Input interface

17 Real Time Clock (RTC)

18 Reading unit interface

19 Communication device

20,21 ID tag

22 Tunnel-shaped-cover

30 Barcode

W,W′ Throwing-in prevention wall

### DETAILED DESCRIPTION OF THE INVENTION

In order to solve the said problems, as present invention, the food and drink managing device in circulation type carrying path for providing food/drink containers mounting foods and drinks to customers by an endless circulating carrying path is characterized by including an identification information reading means that enables to read the identification information which is given on said food/drink container to be able to identify individual food/drink containers, and is provided near said circulating carrying path, at least one sign parts circulating and moving as linked with said circulating carrying path, a pass-through detection means which is provided near said circulating carrying path to detect passing through of said sign parts, a registering means which is connected to said identification information reading means and said pass-through detection means, divides an interval between passing sign parts to be one zone, and registers the identification information of the containers read by said identification information reading means, as foods and drinks in supplying, by coordinating it with a zone in which the containers exist, and food/drink containers throwing-in prohibited area with the given length from the place of provided identification information reading means towards the upper side of circulation carrying path.

In this way, it reduces the number of said identification information reading means, for example, by one of them, it will register identification information of food/drink container to said registering device in response to existing zone of said food/drink container, and if even in the pass step of said sign parts that correspond to lower side of said zone, the reading of identification information registered as supplying food and drink in response to said zone, will not success, it can be precisely judged that the said supplying food and drink is removed by customer, and not only will it reduces the burden of conduct by simplifying these judging conduct, but also, for example by placing with adding properly the said sign parts, alike the case that quite a number of the prior identification information means are placed, it enables to get the quality of real-time of managing information, and in consequence it will prevent heavy loss of real-time quality of managing substance, without increasing the burden of conduct in managing conduct, and will hold down the cost of whole device. Furthermore, because the food/drink container throwing-in prohibited area with prescribed length is placed towards the upper side of circulation carrying path from settled position of identification information reading means, in throwing-in moment of food/drink container, the food/drink containers that are on lower side than throwing-in area are not temporarily running or overlapping with another one in the place of identification information reading means, and so, the reading of the identification information will be able to be accurately executed.

As present invention, it is preferable that in the food and drink managing device in circulation type carrying path, said food/drink container throwing-in prohibited area has throwing-in protecting wall going along circulation carrying path.

In this way, it will prevent the throwing-in by throwing-in preventing wall even if by mistake one tried to throw-in the food/drink container near the place, which has identification information reading means.

As present invention, it is preferable that in the food and drink managing device in circulation type carrying path, there is tunnel-shaped-cover that covers circulating food/drink container in said food/drink container throwing-in prohibited area.

In this way, it prevents the throwing-in by tunnel-shaped-cover that covers food/drink container, and enables to read identification information precisely by reading means.

As present invention, it is preferable that in the food and drink managing device in circulation type carrying path, there is said identification information reading means inside said, tunnel-shaped-cover, and electromagnet shield is given on the surface of said tunnel-shaped-cover.

In this way, there is no need to worry about the disruption of reading of identification information from reading device with the interference of other electric wave.

As present invention, it is preferable that in the food and drink managing device in circulation type carrying path, there are said several sign parts of which each is settled in almost equal interval on circulation type carrying path.

In this way, not only will the maximum of food and drink that exists in each zone will be almost identical, but also, because the conveying speed of circulation carrying path is almost equal in general, it is possible to make the transiting interval of said sign parts to be almost identical and, enables to operate the managing conduct efficiently.

As present invention, it is preferable that in the food and drink managing device in circulation type carrying path, said sign parts has sign identification information readable by said identification information reading means, and said identification information reading means is combined with said pass-through detection means.

In this way, because sign identification information reading means is combined with the pass-through detection means, the cost of whole device will be low.

As present invention, it is preferable that in the food and drink managing device in circulation type carrying path, said registering means, when detecting new identification information by said identification information reading means, registers the identification information with relating the time information in that moment.

In this way, by comparing the said time information and present time, the estimated passed time of that food and drink on circulation carrying path can be known, for example, control of the freshness of food and drink by using these passed time can be operated.

As present invention, it is preferable that in the food and drink managing device in circulation type caring path, said registering means, when said sign parts in the lower side of said zone passed and the identification information registered as supplying food and drink by coordinating it with the z, one would not be detected, changes the record of identification information to one of removing food and drink, and registers the time information of said registering change by coordinating it with identification information, and further, holds said registration in the specified time.

In this way, the specified time that holds said registering, for example, is set little shorter than the time when after eating and drinking, food/drink containers are collected, washed and used again, 15 minutes as an example, and even in the case when customer removed the food and drink from carying path and returned the food and drink to the different zone, when identification ID of the food/drink container that has food and drink was read again, if the same identification information as one of said removed food and drink exists, it can be judged that the food and drink are returned to the carrying path by customer, and the mismatching of management information by the returning of these food and drink will be prevented.

As present invention, it is preferable that in the food and drink managing device in circulation type carrying path, said registering means can change said specified retention time for said registration of removing food and drink.

In this way, like aforesaid, times such as the time when after eating and drinking, food/drink containers are collected, washed and used again, is generally different in each restaurant, present invention enables to set up those time in accordance within each restaurant.

As present invention, it is preferable that in the food and drink managing device in circulation type carrying path, said identification information reading means can read the identification information given on said food/drink container without contacting.

In this way, present invention eliminates the problems during reading such as attrition of food and drink container.

As present invention, it is preferable that in the food and drink managing device in circulation type carrying path, the giving on the identification information to said food/drink container is providing ID tag, which can send ID as stored identification information by wireless, to food/drink container.

In this way, ID reading will be done by wireless, and stable reading will be conducted without the reading error by the problems such as food and drinks location or dirt.

As present invention, it is preferable that in the food and drink managing device in circulation type carrying path, said identification information can identify the price information of food and drink.

In this way, present invention enables to manage the price of food and drink supplied on carrying path at the same time.

As present invention, it is preferable that in the food and drink managing device in circulation type carrying path, said identification information reading means is provided on lower part near food/drink throwing-in area in circulation carrying path.

In this way, the error between the actual time of throwing-in and the registering time with new detection by identification information reading means will lessen.

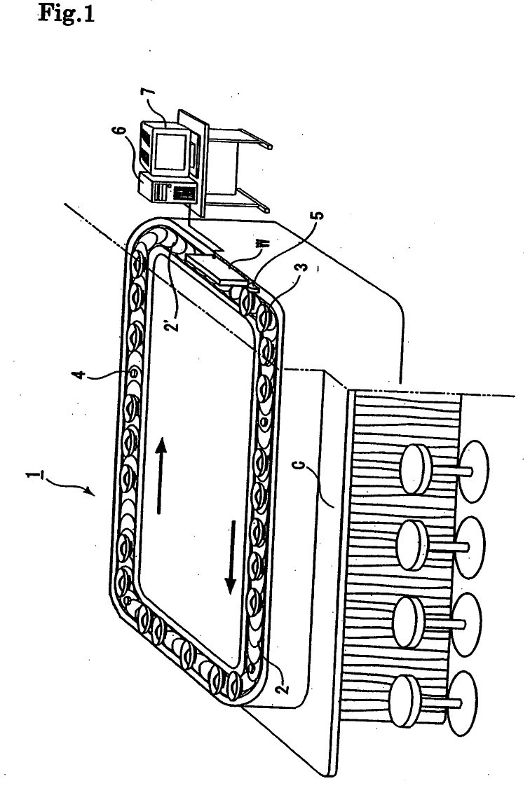

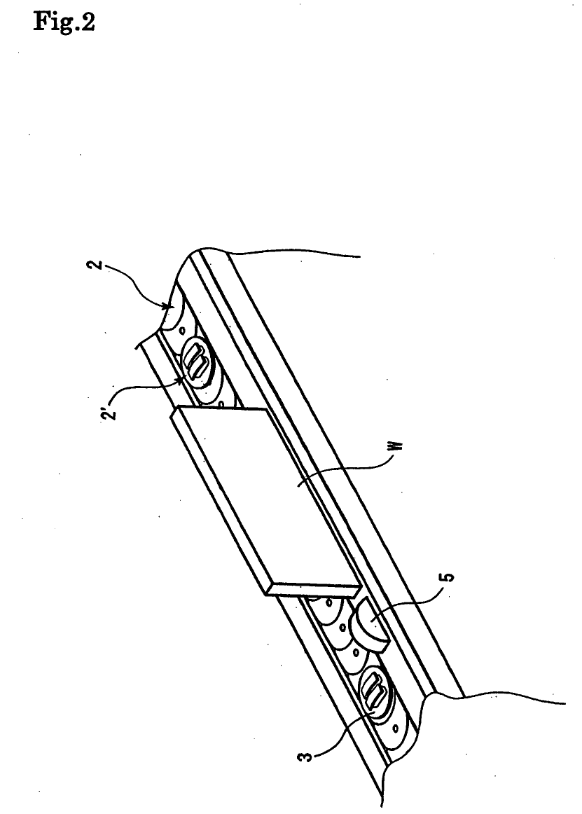

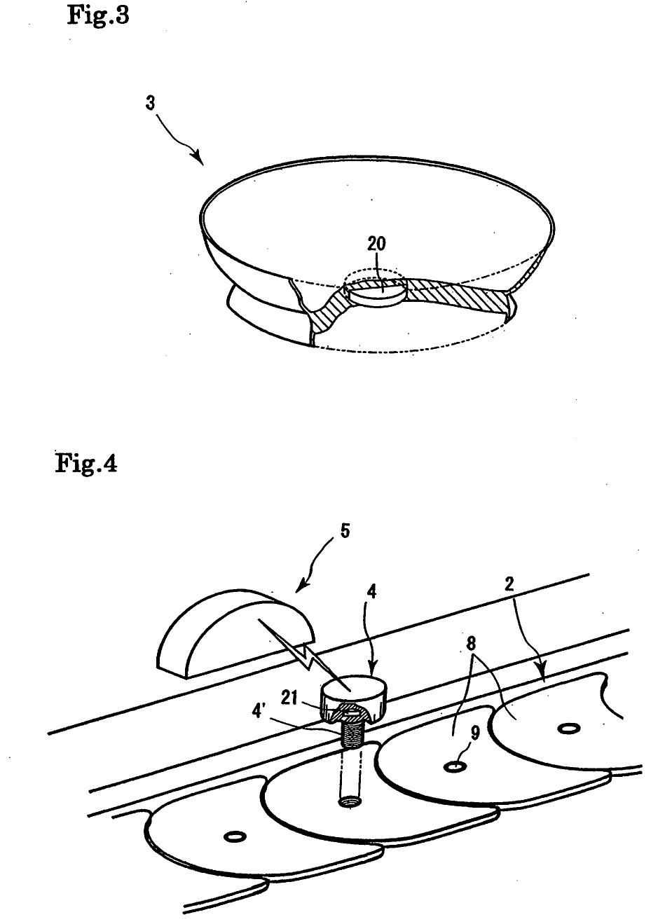

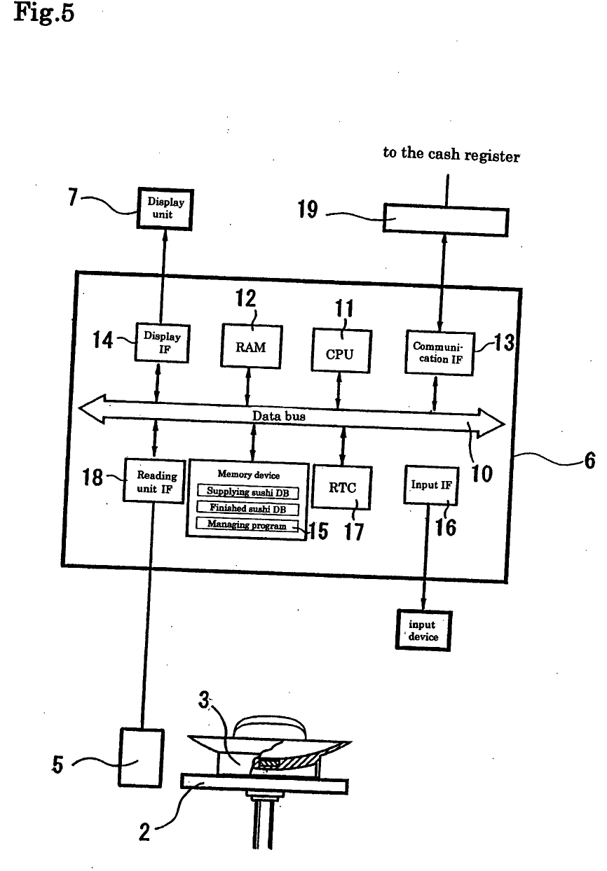

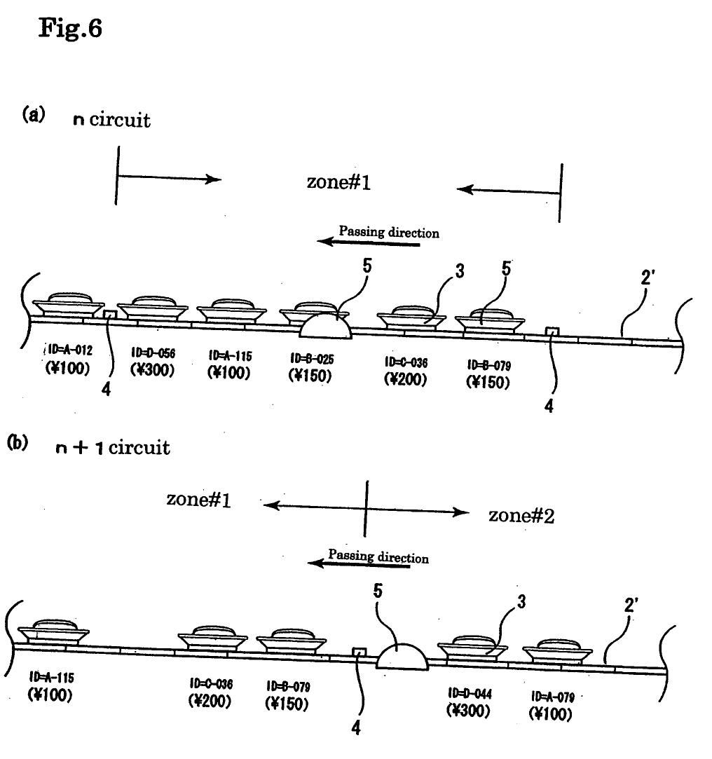

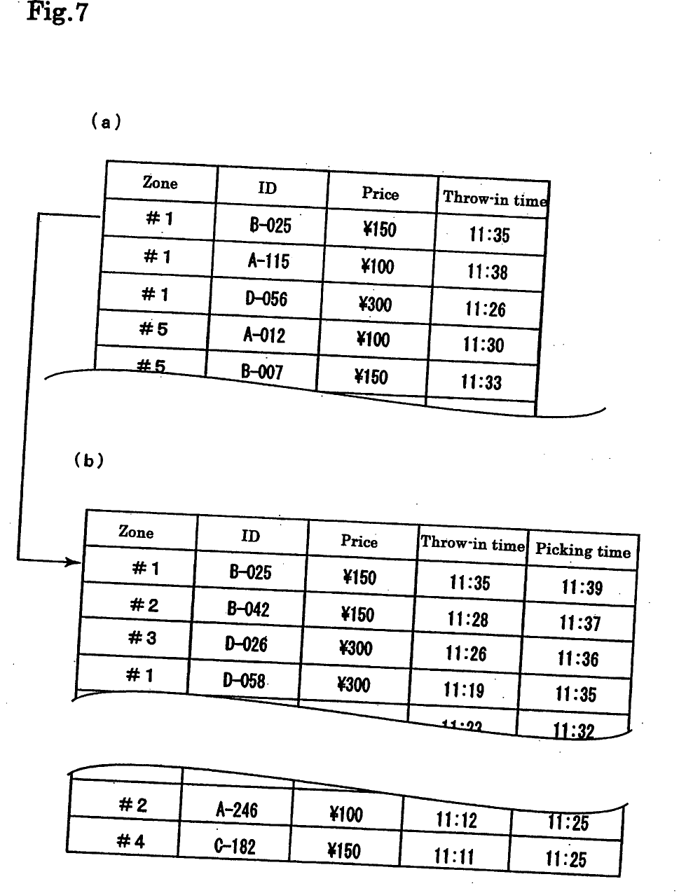

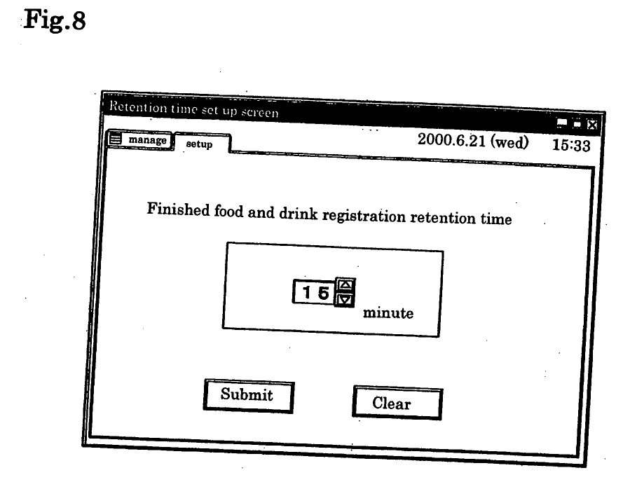

Following is the explanation of present invention based on drawings. FIG. 1 is a view showing a squinting overview frame format of food and drink managing device in circulation type carrying path, as present invention example. FIG. 2 is a squinting view near the throwing-in area of kitchen side. FIG. 3 is a partly fractured squinting overview that shows the Sushi plate that has the ID tag built-in, which is food/drink container used in present invention example. FIG. 4 is a squinting view that shows the fixing condition of sign parts that has the ID tag built-in, to circulation type carrying path used in present example. FIG. 5 is a block diagram that shows the structure of food and drink managing device of present invention example. FIGS. 6(a) and (b) are both the explanation drawings to explain the managing condition of food and drink managing device of present invention example. FIG. 7(a) is a table that shows the organization of supplying Sushi data base in food and drink managing device in present invention example, and FIG. 7(b) is a table that shows the organization of finished Sushi data base in food and drink managing device in present invention example. In addition, FIG. 8 is a drawing that shows the screen to set the retention time in the managing computer of present invention example.

First, food and drink managing device 1 in circulation type carrying path, as present invention example, has external construction described in FIG. 1. It has flat top chain conveyor 2 which is circulation type carrying path and settled along counter C with endlessness. One of these parts, which are the right part of dotted line, is kitchen. Each Sushi as food and drink is set on Sushi plate 3 as food and drink container, and each Sushi will be thrown in to said flat top chain conveyor 2 from the throwing-in area 2′ which is placed in this kitchen, and conveyed on said flat top chain conveyor 2, and offered to the customer in dinning counter C.

In addition, in the lower part of the conveying direction near throwing-in area 2′ settled in said kitchen, and in the near circumference of said flat top chain conveyor 2, as described in FIG. 3, one reading unit 5 as identification information reading means is placed, which has the ability to read the ID of Sushi plate passed on the flat top chain conveyor with receiving the transmission of ID from ID tag 20 embedded inside Sushi plate 3.

As described in FIG. 2, this reading unit 5 has prescribed length throwing-in prevention wall W from the place of settled the reading unit towards the upper side of circulation carrying path. The place of the throwing-in prevention wall W forms the food and drink throwing-in prohibition area, and throwing-in can only be done on the far upper side than throwing-in prevention wall W.

Furthermore, as described in FIG. 1, this reading unit 5 is connected to managing computer 6 as the registering device that is settled inside the kitchen, and is made to output the read ID of said Sushi plate 3 to said managing computer 6. Mainly, these managing computers 6 and reading unit 5 is forming the food and drink managing device of present invention.

Inside the these Sushi plate 3 made of resin used in present invention example, as described in FIG. 3, ID tag 20 that has nonvolatile memory of memorizing specific ID as identical information, and ability to send said memorized ID by electromagnetic wave with prescribed frequency, is buried inside the heavy-walled part that is comparatively thick in the bottom of the plate, and by the ID sent from these ID tags each Sushi plate 3 can be identified.

In addition, on these Sushi plates 3, in present invention example, the patterns that fits each price (100 yen, 150 yen, 200 yen, 300 yen is used in present example) are printed, and said ID tags 20 of plates with patterns related to each price, are given ID, for example ID starting from “A” such as “A-001, A-002, . . . ” in 100 yen patterned plates, ID starting from “B” in 150 yen patterned plates, ID starting from “C” in 200 yen patterned plates, and ID starting from “D” in 300 yen patterned plates. By reading these ID, the price of Sushi plates 3 is able to be judged. And by putting on the patterned plate the kind of Sushi with same price as the price given to said plate in said kitchen, and throwing-in the plate of Sushi from said throwing-in area, the price of Sushi plate 3 and the price of each Sushi are made to be identical.

In addition, in flat top chain conveyor 2 of present invention, sign parts 4 which is placed almost equally with prescribed interval, as described in FIG. 1 or FIG. 4, are fixated by screw parts 4′ fitted to the rotation axis 9 that supports crescent stat 8 shaped as tough semi-lunar with possibility of relative rotation. Inside said sign parts 4, alike the one used in said Sushi plate 3, ID tag 21 which is readable by said reading unit 5 is embedded, and each ID tag 21 is given “P-001˜P-005” as ID that shows the “position” which is position of carrying path, and carrying path is divided to 5 zone, #1˜#5, by each of these sign parts 4

In present invention example, in this way, by embedding ID tag 21, which is readable by reading unit 5, inside said sign parts 4 alike said Sushi plate 3, said reading unit 5 is made to combine pass-through detection device in present invention. By this way, there are no need to place these pass-through detection devices individually, and it is preferable because it will enable to cost down and simplify the device, however, present invention is not limited in this way, and for these pass-through detection device it is also accepted to use the individual device such as transit sensor which detects the said sign parts 4 with light and etc.

In addition, in present invention example, said sign parts 4 is placed on the crescent stat 8 as sticking out. This structure can prevent Sushi plate 3 to be placed on said sign parts 4 and stride across zones, and even if said crescent stat 8 was made of metal, it is preferable because the reading of said reading unit 5 can be done favorably, however, present invention is not limited in this way, and it is optional that these sign parts 4 are embedded in crescent stat 8 made of resin, and the shape and formation of these sign parts 4 can also be optional if said sign parts 4 is made to move in conjunction with said flat top chain conveyor 2.

Said reading device 5 that reads ID of These sign parts 4 and said Sushi plate 3 is connected to managing computer 6 that is placed inside the kitchen, as described in FIG. 5, and the structure of managing computer used in present invention example is similar to general computer that includes data bus 10 that sends or receives the data inside computer 6, central processing unit (CPU) 11 that will execute variously registration processing, RAM 12, real time clock (RTC) 17 that has ability to output the calendar information such as present time data or a day of the week on optional date, input interface (IF) 16 that is connectable to input device such as key board, display interface (IF) 14 that is connected to display device such as display 7, transmission interface 13 that send and receive the data by connected to transmission device 19 that conducts the transmission with exterior device such as cash register, reading unit interface (IF) 18 that is connected to said reading unit, memory device 15, formed by magnetic disk or optical magnetic disk, that includes managing program which is describing detail of various conducts carried out by said CPU 11, such as registration conduct or managing conduct, supplying Sushi data base (DB) which is registering ID of Sushi plate 3 existing on said flat top chain conveyor, corresponding to each zone that has said Sushi plate 3, with the new detected time of said Sushi plate 3 by said reading device, as described in FIG. 7(a), and finished Sushi data base (DB) that is changing and registering the record of Sushi plate 3 which becomes non detected by said reading unit 5 when customer picks out from flat top chain conveyor 2, as described in FIG. 7(b).

In what follows, the movement of managing device of present invention example is explained by using FIG. 1, FIG. 6, and FIG. 7, first of all, in the kitchen, Sushi is placed on Sushi plate 3 that has the pattern corresponding to its price and will be thrown-in to flat top chain conveyor 2 from throwing-in area described in FIG. 1.

Even if Sushi plate 3 on the lower side runs by said throwing-in, because the position of throwing-in is away from reading unit 5, in addition, even if it is tried to throw-in on the upper side of reading unit 6, since such throwing-in can not be done by the throwing-in prevention wall W, reading unit 5 can precisely read each ID of Sushi plate 3

In addition, the length of this throwing-in prevention wall W is the length that is necessary for food/drink container throwing-in prohibited zone, in other word, it is accepted if it has the length that would not affect the reading of reading unit 5 even if Sushi plate runs at throwing-in moment.

With the passage of Sushi plate 3, the ID of such Sushi plate 3, for example in the circumstance described in FIG. 6(a), ID “B-025” which is 150 yen Sushi is read by reading unit 5 and said ID “B-025” will be out putted to said managing computer 6.

With based on said output, managing computer 6 win search the existence of read ID “B-025” in supplying Sushi data base (DB) and finished Sushi data base (DB) that are memorized in said memory device 15, in case if each data base (DB) did not have identical ID, as described in FIG. 7(a), it registers ID “13-025” as Sushi thrown-in newly, in supplying Sushi data base (DB), with the zone “#1” which such Sushi exists, and with the time data.

Those thrown-in and conveyed Sushi is offered to customer, supposing that Sushi of said ID “B-025” is ate (picked out) by customer, in next round, at the moment of detecting ID “P-002” given to the sign parts 4 which is the lower side of zone “#1”, because the reading of said ID “B-025” will not be done, managing computer 6 will judge that Sushi of ID “B-025” non-detected in these zone “#1” is ate or drank, as described in FIG. 7(b), and will change and register the registered information of said ID with time data of that moment into finished Sushi data base (DB).

The data which is changed and registered in the finished Sushi data base (DB) will be retained and will be erased in turn when the specified retention time will pass. For example, in case it takes about 30 minutes to eat generally, wash the Sushi plate 3 after meal, and throw-in said Sushi plate 3 once again to carrying path, in the setup screen described in FIG. 8, 15 minutes as suitable time which is shorter than said time (30 minutes) will be set. Said data will be retained from the time of aforesaid changing and registering until passing of said set time, and will be erased in turn after 15 minute passes.

By this way, after customer once removed food and drink from carrying path for eating and drinking, and returned them to the different zone of carrying path, said food and drink will be once registered to finished Sushi data base (DB) at the passage of recorded zone in relation to them, however, when said food and drink will be detected in other zone, because there are identical ID in finished Sushi data base (DB), Sushi of said ID can expect as the one returned to carrying path, and by changing the record of said ID to supplying Sushi data base (DB) in response to re-detected zone, it is made to prevent the mismatch of data carried out by “returning” of the customer.

Above all are the explanations of present, invention by using the figures, however, present invention is not limited in these examples, and it is obvious that present invention will also involve the changes or addition without departing from the scope of present inventions.

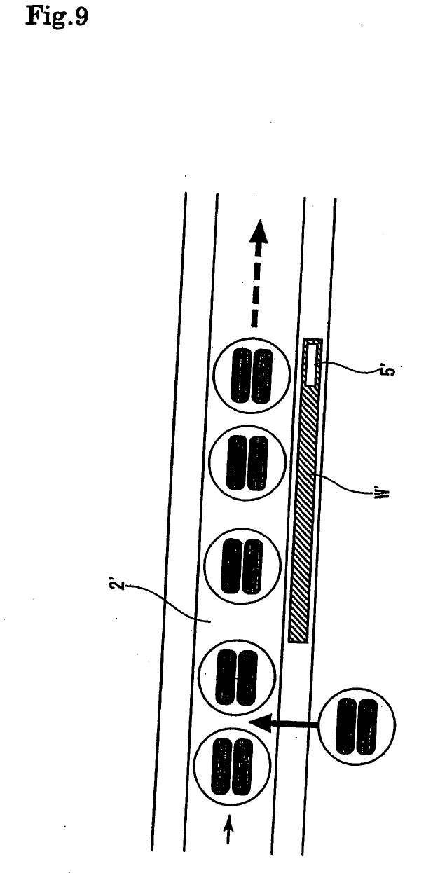

For example, in examples aforesaid, throwing-in prevention wall and reading unit was placed separately, however, as described in FIG. 9, it is accepted to build in the reading unit to throwing-in prevention wall. FIG. 9 is the plain diagram view near the throwing-in area that shows the other alternative practical invention example of throwing-in prevention wall W′. Throwing-in prevention wall W′ is formed with prescribed length in the lower side of throwing-in area 2′, and reading unit 5′ is built in to the lower edge of throwing-in prevention wall W′.

By this way, wherever throwing-in prevention wall W is placed, because reading unit 5′ is protected by throwing-in prevention wall W′, reading error will not occur.

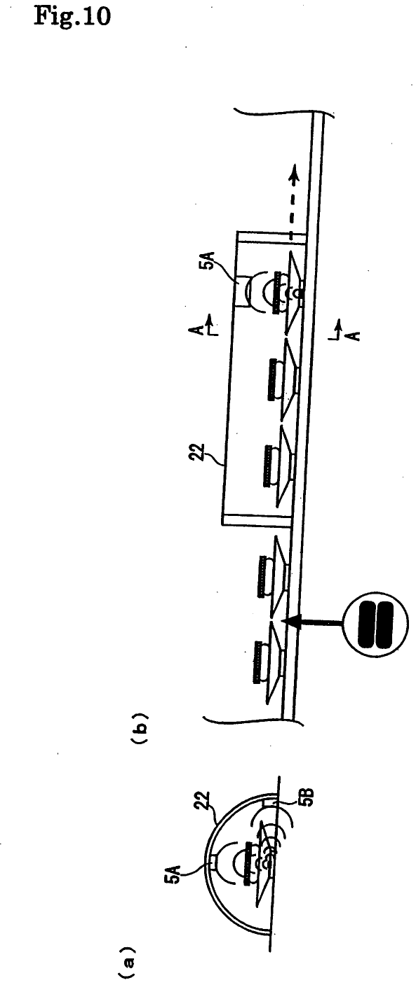

Furthermore, FIG. 10 is the view that settled the tunnel-shaped-cover to the prohibited area of throwing-in food/drink container as an alternative of throwing-in prevention wall, (a) is the cross-section diagram A-A of (b), (b) is the side view near the throwing-in area. Reading unit 5A is placed on the upper part of tunnel-shaped-cover 22, reading unit 5B is place at the side of tunnel-shaped-cover 22, and with them it double-checks the reading of ID. In this way, reading miss will highly decrease. It is surely accepted by just placing whichever of reading unit inside tunnel-shaped-cover 22. It is also possible to prevent the reading error caused by other electromagnetic wave, by giving electric wave shield on the surface of tunnel-shaped-cover 22.

In addition, in example aforesaid, two of reading units 5 are used, but present invention is not limit by this. the number of reading units 5 can be increased within the limits of permitted cost.

In addition, in example aforesaid, said sign parts 4 is placed almost with equal interval length, but present invention is not limit by this.

In addition, in example aforesaid, when the Sushi is ate by customer and will become non-detective, it changes the record, but present invention is not limited by this, and as an alternative to this change of record, by erasing the record, it is also accepted to simply manage the Sushi which is only on the carrying path, with using aforesaid supplying Sushi data base (DB).

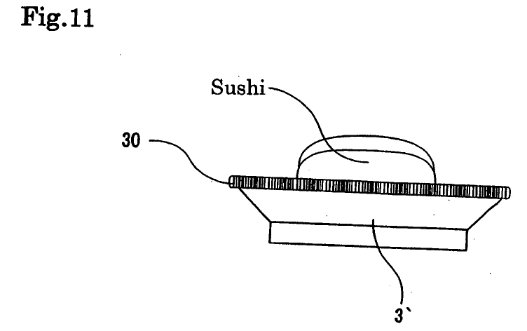

In addition, in example aforesaid, said ID tags 20, 21 is used in order to read ID data without touching, such thing is preferable because it enables to stably read without depending on location and direction or dirt of Sushi plate 3, however, present invention is not limited by this, for example of non-touching reading method, it is also accepted to use bar-code described in FIG. 11. FIG. 11 is the side view that shows the Sushi plate with bar-code wherein bar-code 30 with registered the ID is placed around the edge side of top edge of Sushi plate 3′, and enable to be read without touching.

In addition, though it is not done in aforesaid examples, it is optionally accepted to collect the Sushi which losses it's flavor automatically by taking out the prescribed round conveyed or prescribed time conveyed Sushi after throwing-in, by placing removable instrument with connected to said managing computer, such as removing device for removing the Sushi plate 3 on carrying path.

Present invention examples use Sushi as an example of food and drink, however, it is not limited only to Sushi and obviously it can also be used with other varieties of food and drink.

Present invention has following effect

(a) According to the invention related to claim 1, it reduces the number of said identification information reading means, for example, by one of them, it will register identification information of food/drink container to said registering device in response to existing zone of said food/drink container, and if even in the pass step of said sign parts that correspond to lower side of said zone, the reading of identification information registered as supplying food and drink in response to said zone, will not success, it can be precisely judged that the said supplying food and drink is removed by customer, and not only will it reduces the burden of conduct by simplifying these judging conduct, but also, for example by placing with adding properly the said sign parts, alike the case that quite a number of the prior identification information means are placed, it enables to get the quality of real-time of managing information, and in consequence it will prevent heavy loss of real-time quality of managing substance, without increasing the burden of conduct in managing conduct, and will hold down the cost of whole device. Furthermore, because the food/drink container throwing-in prohibited area with prescribed length is placed towards the upper side of circulation carrying path from settled position of identification information reading means, in throwing-in moment of food/drink container, the food/drink containers that are on lower side than throwing-in area are not temporarily running or overlapping with another one in the place of identification information reading means, and so, the reading of the identification information will be able to be accurately executed.

(b) According to the invention related to claim 2, it will prevent the throwing-in by throwing-in preventing wall even if by mistake one tried to throw-in the food/drink container near the place, which has identification information reading means.

(c) According to the invention related to claim 3, it prevents the throwing-in by tunnel-shaped-cover that covers food/drink container, and enables to read identification information precisely by reading means.

(d) According to the invention related to claim 4, there is no need to, worry about the disruption of reading of identification information from reading device with the interference of other electric wave.

(e) According to the invention related to claim 5, not only will the maximum of food and drink that exists in each zone will be almost identical, but also, because the conveying speed of circulation carrying path is almost equal in general, it is possible to make the transiting interval of said sign parts to be almost identical and, enables to operate the managing conduct efficiently.

(f) According to the invention related to claim 6, because sign identification information reading means is combined with the pass-through detection means, the cost of whole device will be low.

(g) According to the invention related to claim 7, by comparing the said time information and present time, the estimated passed time of that food and drink on circulation carrying path can be known, for example, control of the freshness of food and drink by using these passed time can be operated.

(h) According to the invention related to claim 8, the specified time that holds said registering, for example, is set little shorter than the time when after eating and drinking, food/drink containers are collected, washed and used again, 15 minutes as an example, and even in the case when customer removed the food and drink from caring path and returned the food and drink to the different zone, when identification ID of the food/drink container that has food and drink was read again, if the same identification information as one of said removed food and drink exists, it can be judged that the food and drink are returned to the carrying path by customer, and the mismatching of management information by the returning of these food and drink will be prevented.

(i) According to the invention related to claim 9, like aforesaid, times such as the time when after eating and drinking, food/drink containers are collected, washed and used again, is generally different in each restaurant, present invention enables to set up those time in accordance within each restaurant.

(j) According to the invention related to claim 10, present invention eliminates the problems during reading such as attrition of food and drink container.

(k) According to the invention related to claim 11, ID reading will be done by wireless, and stable reading will be conducted without the reading error by the problems such as food and drinks location or dirt.

(l) According to the invention related to claim 12, present invention enables to manage the price of food and drink supplied on carrying path at the same time.

(m) According to the invention related to claim 13, the error between the actual time of throwing-in and the registering time with new detection by identification information reading means will lessen.

1. The food and drink managing device in circulation type carrying path for providing food/drink containers mounting foods and drinks to customers by an endless circulating carrying path, including;
an identification information reading means that enables to read the identification information which is given on said food/drink container to be able to identify individual food/drink containers, and is provided near said circulating carrying path,
at least one sign parts circulating and moving as linked with said circulating carrying path,
a pass-through detection means which is provided near said circulating carrying path to detect passing through of said sign parts,
a registering means which is connected to said identification information reading means and said pass-through detection means, divides an interval between passing sign parts to be one zone, and registers the identification information of the containers read by said identification information reading means, as foods and drinks in supplying, by coordinating it with a zone in which the containers exist,
and food/drink containers throwing-in prohibited area with the given length from the place of provided identification information reading means towards the upper side of circulation carrying path.

2. The food and drink managing device in circulation type carrying path as claimed in claim 1, wherein said food/drink container throwing-in prohibited area has throwing-in protecting wall going along circulation carrying path.

3. The food and drink managing device in circulation type carrying path as claimed in claim 1, wherein said food/drink container throwing-in prohibited area has tunnel-shaped-cover that covers food/drink containers circulating.

4. The food and drink managing device in circulation type carrying path as claimed in claim 3, including said identification information reading means inside said tunnel-shaped-cover, and electromagnet shield on the surface of said tunnel-shaped-cover.

5. The food and drink managing device in circulation type carrying path as claimed in whichever of claim 1˜4, including said several sign parts of which each is settled in almost equal interval on circulation type carrying path.

6. The food and drink managing device in circulation type carrying path as claimed in claim 1˜5, wherein said sign parts has sign identification information readable by said identification information reading means, and said identification information reading means is combined with said pass-through detection means.

7. The food and drink managing device in circulation type carrying path as claimed in whichever of claim 1˜6, wherein said registering means, when detecting new identification information by said identification information reading means, registers the identification information with relating the time information in that moment.

8. The food and drink managing device in circulation type carrying path as claimed in whichever of claim 1˜7, wherein said registering means, when said sign parts in the lower side of said zone passed and the identification information registered as supplying food and drink by coordinating it with the zone would not be detected, changes the record of identification information to one of removing food and drink, and registers the time information of said registering change by coordinating it with identification information, and further, holds said registration in the specified time.

9. The food and drink managing device in circulation type carrying path as claimed in claim 8, wherein said registering means can change said specified retention time for said registration of removing food and drink.

10. The food and drink managing device in circulation type carrying path as claimed in whichever of claim 1˜9, wherein said identification information reading means can read the identification information given on said food/drink container without contacting.

11. The food and drink managing device in circulation type carrying path as claimed in claim 10, wherein the giving on the identification information to said food/drink container is providing ID tag, which can send ID as stored identification information by wireless, to food/drink container.

12. The food and drink managing device in circulation type carrying path as claimed in whichever of claim 1˜11, wherein said identification information can identify the price information of food and drink.

13. The food and drink managing device in circulation type carrying path as claimed in whichever of claim 1˜12, wherein said identification information reading means is provided on lower part near food/drink throwing-in area in circulation carrying path.
